(19) United States
(12) Patent Application Publication
(10) Pub. No.: US 2025/0003681 A1
(43) Pub. Date: Jan. 2, 2025

(54) IMPROVEMENT IN A VERTICAL KILN

(71) Applicant: Cemal ÜNLÜ, Etimesgut, Ankara (TR)

(72) Inventor: Cemal ÜNLÜ, Etimesgut, Ankara (TR)

(21) Appl. No.: 18/707,070

(22) PCT Filed: Nov. 4, 2022
(86) PCT No.: PCT/TR2022/051243

§ 371 Date: May 2, 2024

(30) Foreign Application Priority Data
Nov. 30, 2021 (TR) 2021/018846

(51) Int. Cl. F27B 1/22; B01J 6/00; F27D 17/00

(52) U.S. Cl. CPC F27B 1/22; F27D 17/004; B01J 6/001

(57) ABSTRACT

Disclosed is a vertical kiln which can be used in calcination and/or drying processes in industrial plants operating in the mining sector

### FIELD OF INVENTION

The invention relates to the improvement in a vertical kiln designed for the calcination and/or calcination in industrial plants operating in the mining sector

### CURRENT STATE OF THE ART

The process that is indispensable in industrial gypsum, lime, cement etc. plants is carried out by calcination and/or drying kilns

### PURPOSE OF THE INVENTION

To reduce the amount of energy consumed in calcination and/or drying processes in industrial plants operating in the mining sector. Our vertical drying kiln is more efficient than its counterparts. It carries out the drying process 40-50% cheaper. Efficiency is also increased with the improvement made in the vertical kiln.

It can also be used in industrial gypsum, lime, cement plants as well as bentonite, asphalt plant, calcite, limestone, dolamite etc. plants

### FIGURES THAT WILL HELP TO EXPLAIN THE INVENTION

FIG. 1—Images and parts of the kiln developed

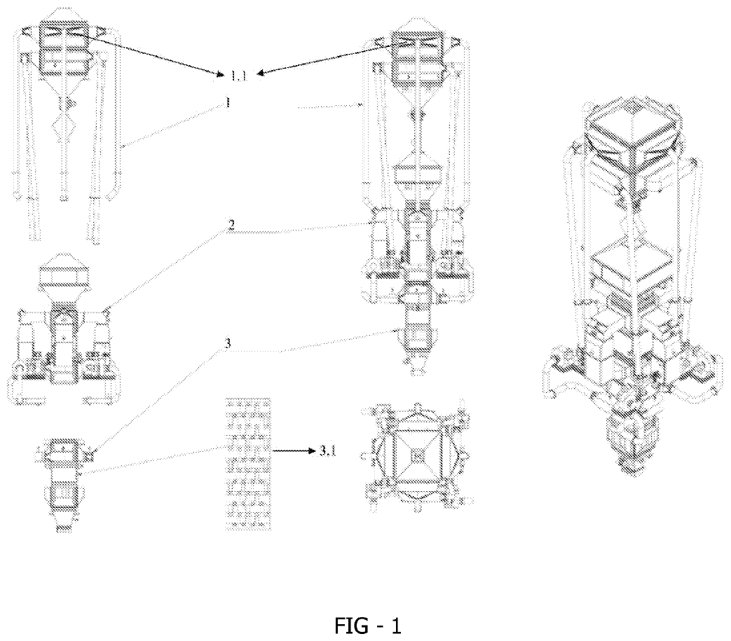

### NAMES OF PARTS IN THE FIGURE

1—Preheating part
1.1 Preheater module structures/chambers
2—Burnerg part
3—Cooling chute
3.1 Heat exchanger system

### DETAILED DESCRIPTION OF THE INVENTION

The invention relates to the improvement in vertical kilns designed for use in calcination and/or drying processes in industrial plants operating in the mining sector.

The simplest way to remove the physically bound water in the concentrate is to heat the materials to a temperature (drying) above the evaporation temperature of water. Evaporation of water is an endothermic process (+44 KJ/mol); therefore, energy is required to heat the minerals to the desired temperature and during evaporation. Calcination is referred to as mineral chemical disintegration; and happens when heating the mineral above the disintegration temperature or reducing the partial vapor pressures of the gaseous products to values below the equilibrium vapor pressure during the disintegration reaction at a specified temperature. Calcination takes place in minerals with relatively low decomposition temperature of water, CO2 and other gases chemically bound to metal hydrate and carbonate minerals. Drying and calcination takes place in rotary kilns, shaft kilns and fluidized bed furnaces. The reasons why water in minerals is undesirable are: (i) removal of water reduces the raw material to be processed; (ii) if the material is to be fed into a furnace that operates at high temperatures, such as an electric arc furnace, the sudden transition of water to the vapor can cause large-scale scattering; (iii) in some cases, materials may become more reactive after removal of water; (iv) the presence of coarse grained limestone causes some undesirable reactions and results in poor product quality and yield.

In industrial applications, the most suitable method for the combustion (disintegration) of coarse-grained limestone is the Vertical Kiln. Our invention is described in the application numbered 2021/012627.

Combustion module structures/chambers working with 1 heat furnace (burner) in vertical kiln numbered 2021/012627 (1-1. 1) has been increased to 4 heat furnaces in our invention and the system has been made more efficient in terms of calcination, and the heat exchanger system (3), which has the task of separating the hot water vapor in the product in the system, and it has increased its efficiency by blending the hot water with air and re-introducing the dry and hot air into the system and using this air to preheat the product (preheater chamber) (1-1.1) and to further reduce fuel consumption.

In addition, the pure water separated in the heat exchanger system (3.1) can be used as a supplement to other parts of the plant that need pure water.

In the vertical furnace mentioned in the application numbered 2021/012627, the material enters the machine through the inlet and feedback module on the upper part, hot air is supplied to the machine through the hot air inlet channel on the lower part, and since the vertical operation principle is adopted, movement and transfer, it operates with the fill and discharge method by providing hot air and gas flow without the need for additional energy.

In addition to the furnace body, preheater module structures/chambers (1) are supported by heat exchanger system (3) for the purpose of evaluating the water vapor coming out of the system and Apr. 8, 2012 and more burners (depending on capacity and product) to calcine the general system.

### APPLICATION TO INDUSTRY

The invention relates to the development of a vertical kiln designed to be used in calcination and/or drying processes in industrial plants operating in the mining sector (construction chemicals plants, calcite production plants, cement plants, lime plants).

### ADVANTAGES AND FEATURES

Preheater module structures/chambers (1-1.1) working with 1 heat furnace (burner) in the vertical furnace numbered 2021/012627 have been increased to 4 heat furnaces in our invention and the system has been made more efficient in terms of calcination, and the heat exchanger system (3.1), which has the task of separating the hot water vapor in the product in the system, has increased its efficiency by blending the hot water with air and re-introducing dry and hot air into the system (secondary air) and using this air to preheat the product, aiming to further reduce fuel consumption. In addition to these, the pure water separated in the heat exchanger system (3.1) can be used as a supplement to other parts of the plant that need pure water. With all these advantages and economic gains, it is also a reason for preference.

1. A vertical kiln for use in calcination and/or drying processes in industrial plants operating in the mining sector (construction chemicals plants, calcite production plants, cement plants, lime plants), the vertical kiln comprising:
a heat exchanger system which serves to separate hot water vapor from hot water vapor in the product in the system, allowing the hot water to be blended with air and the dry and hot air to be re-introduced into the system and the separated pure water to be used as a supplement to other parts in the plant that need pure water; and
a preheater module structures/chambers supported by a burner, which may be additionally located in the furnace body depending on the capacity and the product to calcine the system.
